(19) United States
(12) Patent Application Publication
(10) Pub. No.: US 2025/0187113 A1
(43) Pub. Date: Jun. 12, 2025

(54) THE CONCEPT FOR MULTI-LASER HEADS IN-SITU BRAKE DISC HIGH-SPEED CLADDING FOR PROTECTION AGAINST WEAR AND CORROSION

(71) Applicant: OERLIKON METCO AG, WOHLEN, WOHLEN (CH)

(72) Inventors: JOERG SPATZIER, URDORF (CH); MEHMET KEMAL COSKUN, BADEN (CH); ARKADI ZIKIN, WOHLEN (CH); HOSSEIN NAJAFI, OTHMARSINGEN (CH)

(21) Appl. No.: 18/846,804

(22) PCT Filed: Mar. 7, 2023
(86) PCT No.: PCT/EP2023/000019

§ 371 Date: Sep. 13, 2024

(30) Foreign Application Priority Data
Mar. 15, 2022 (DE) 10 2022 000 899.8

(51) Int. Cl. B23K 26/34; B23K 26/08; B23K 101/34; F16D 65/12

(52) U.S. Cl. CPC B23K 26/34; B23K 26/0823; F16D 65/127; B23K 2101/34; F16D 2250/0046

(57) ABSTRACT

A method to produce a coated brake disc, the method including the steps of:—providing a brake disc with a first and a second friction surface—coating at least part of the first friction surface by a laser cladding process wherein for the laser cladding process more than one, preferably two or especially preferred at least three laser and processing heads are used and at least during part of the laser cladding process the preferably two or especially preferred at least three laser and processing heads are used simultaneously at different locations of the first friction surface.

The present invention relates to a method for laser cladding of friction surfaces of brake discs with more than one laser and processing heads (LPH) performing the cladding process simultaneously at different locations on the same friction surface.

Requirements driven by the market to increase the life time of brake discs together with tightening fine dust emissions regulations, as one of the main pollution elements in the vehicle is the braking system (disc and pad), have led to an increasing demand for brake discs with a durable corrosion resistance and reduced fine dust emissions to the environment.

A method to increase wear and corrosion resistance and to reduce fine dust emissions of brake discs is to apply a corrosion and wear resistant coating onto the friction surfaces of brake discs. The coating applied to these surfaces combines the advantageous properties of cast iron as a base material, like affordability, good thermal conductivity and mechanical stability at high temperatures with the benefits of the coating like increased corrosion and wear resistance compared to the base material.

A prior art approach as outlined in EP1336054A1 reveals a brake disc coated with a metallic non-ceramic coating that shows higher oxidation and wear resistance than the cast iron core, the process being used for the coating is plasma-, flame- or wire-coating.

As described in DE102014006064A, the application of a cermet coating, consisting of a metallic matrix with oxide-ceramics, on the friction surface further improves corrosion and wear resistance. In order to overcome issues with infiltration corrosion, the application of a nitride-, carbide- and oxide-layer in between the brake disc substrate and the functional top coating can be applied. Furthermore, an intermediate Nickel-based layer to improve the adhesion of the functional top coating may be applied using thermal spray.

One of the challenges with thermally sprayed coatings on cast iron brake discs is that the graphite in form of lamellae and/or spherical particles present at the surface to be coated leads to a low adhesion of the coating as well as water dissipating through the coating or in between the brake disc substrate and the coating leads to rust. Both effects may eventually lead to delamination of the coating.

In order to overcome this, WO2022003189A1 reveals that by using a laser cladding process for coating iron-based substrate materials containing graphite, such as brake discs, graphite lamellae and/or spherical particles on the surface of the substrate can be melted or even evaporated during the coating process. However, graphite particles melting or evaporation during the laser cladding process lead to local defects and locally reduced adhesion. Subsequently the application of an angle ranging from 10° and 45° between an axis perpendicular to the substrate surface and the laser beam is revealed. The advantage of this approach is that on one hand, the adhesion of the coating on the substrate can be increased and on the other hand, laser power levels and thus deposition rates can be increased compared to a process using a laser beam being perpendicular to the substrate to be coated.

As the deposition rates and thus the time to coat a brake disc friction surface are primarily related to the power of the laser, the application of a bond-coat and a protective layer using a high-speed and high-power laser is proposed in another prior art approach. With this approach, processing times of below 110 seconds for the laser cladding of a whole brake disc of a standard size (outer diameter 288 mm; inner diameter 163 mm) can be achieved. To be able to achieve that, high-power lasers of with a power of over 20 kW are required. Using high-power lasers is therefore a reasonable way to scale up the laser-cladding process of brake discs for mass production scenarios.

However, the usage of a high-power laser results in a harm of optical components and the nozzle due to reflection of heat back to the laser and process head. This has, a negative impact on the component lifetime and process stability in terms of powder feed rate to the part. In addition to this, the high power of the laser beam may lead to a deformation of the brake disc due to thermal effects.

Reducing the power of the LPH on the other hand would increase the laser cladding process time to clad a standard brake disc surface. The application of the coating using laser cladding on a friction surface of a brake disc can be performed with the LPH moving radially from the axis of the brake disc towards the outer diameter of the friction surface whilst at the same time the brake disc is rotated around its centerline. In this case, the spot of the laser beam describes a spiral on the surface to be coated. In order to produce a smooth surface an overlap between adjacent lines of coating has to be implemented. If for example the width of the line deposited is 1.5 mm, an overlap of 90% leads to a reasonably smooth surface after laser cladding. Multiplying the width of the line deposited with the overlap results in a radial distance between successive turnings of the spiral of 0.15 mm. Using the difference of the inner (163 mm) and the outer diameter (288 mm) of a standard friction surface of a brake disc to be coated and the distance of 0.15 mm between successive turnings it can be calculated that the length of spiral is 295 m. Using a preferred relative speed of the laser beam on the surface to be coated of 100 m/min it can be calculated that the process time for laser cladding the friction surface on one side of a standard brake disc using a LPH with less than or equal to 6 kW power will be 177 s. Compared to the 110 s needed for laser cladding the same surface with an LPH with 20 kW power it is evident that even though the drawbacks of lower LPH component lifetime and increased stability of the powder deposition of the high-power LPH approach can be overcome by using one lower power LPH, the increased laser cladding process times of this approach will be a disadvantage in an industrialized process.

The objective of the invention therefore is to provide a method to coat a brake disc with a corrosion and wear resistant coating using laser cladding showing low laser cladding process times and improved properties as compared to the prior art.

According to the present invention, the challenge of laser cladding of brake discs with low process times and offering a higher process stability and less wear of the laser and processing head is solved by performing the laser cladding using more than one LPH, preferably two or especially preferred at least three LPH with preferably less than 6 kW power for each LPH simultaneously on the same surface to be coated of the same brake disc, with the spots of the laser beams of the LPH moving in an Archimedean spiral on the surface to be coated.

In order to perform laser cladding of a rotational symmetric friction surface of a brake disc the laser beam moves preferably in a spiral. To achieve this spiral on this surface, either the LPH can be moved in a spiral with the brake disc being stationary or preferably the brake disc is being rotated whilst the LPH moves in the radial direction towards or out from the centerline of the brake disc. In order to better understand the movements during the laser cladding process, the following paragraphs set a formal frame for the description of the movements of the brake disc and the LPH relative to each other.

The position of the laser and processing heads vis a vis the friction surface of the brake disc to be coated can be described with polar coordinates (r,φ) where r is the distance to the rotation axis of the brake disc and φ is the angular coordinate.

The cladding on the surface is performed according to a so called Archimedean spiral which can be described as r=a·φ with “a*2*Π” being the total increase of the radius after 360° of rotation. In the preferred solution, the brake disc is rotated in order to increase the angular coordinate. By rotating the brake disc and increasing the distance of the LPH from the rotation axis a spiral is described.

The length L of the Archimedean spiral can be calculated as:

$$L = \frac{a}{2} [ asinh ( φ ( t ) ) + φ ( t ) \cdot \sqrt{φ {( t )}^{2} + 1} ] \begin{matrix}φ ( {t}_{1} ) \\ φ ( {t}_{0} )\end{matrix}$$

In order to realize a stable deposition process, the deposition speed v is preferably kept constant. As the radius of the spiral increases the angular velocity of the disc needs to be slowed down when the LPH moves in a radial distance away from the centerline of the brake disc. The relation between deposition speed and angular velocity can be expressed in the following manner:

$$v = \frac{dL}{dt} = \frac{dL}{d φ} \frac{d φ}{dt} = a \cdot \sqrt{{φ}^{2} + 1} \cdot \frac{d φ}{dt} = a \cdot \sqrt{{φ}^{2} + 1} \cdot ω ( φ ) = const$$

with ω(φ) being the angular velocity of the disc to be coated at a certain angle j.

Therefore for the cladding process the following two conditions need to be followed:

$$ω ( φ ) = \frac{v}{a \cdot \sqrt{{φ}^{2} + 1}}$$

$$r ( φ ) = a \cdot φ$$

If D is the width of the deposited line and an overlap of x in percent of the next deposited line with the previous line is required, within 360° of rotation of the brake disc the LPH should be moved according to the following relationship:

$$a = \frac{D \cdot ( 100 \% - x ) / 100 \%}{2 π}$$

If we take the example of above with D=1.5 mm and x=90%, then:

$$a = \frac{1.5 mm \cdot 0.1}{2 π} = 0.0239 mm$$

and with v=100 m/min, then:

$$ω ( φ ) = \frac{10000 {0}^{mm} / min}{0.0 \; 239 mm \cdot \sqrt{{φ}^{2} + 1}} \approx 4200000 \cdot 1 / min \cdot \frac{1}{\sqrt{{φ}^{2} + 1}}$$

If the inner diameter of the disc is 163 mm then:

$$φ ( {t}_{0} ) = \frac{r ( {t}_{0} )}{a} = \frac{163 mm}{0.0239 mm} \approx 6800$$

And therefore:

$$ω ( {φ}_{0} ) \approx 42000 \cdot 1 / min \cdot \frac{1}{\sqrt{{( 6800 )}^{2} + 1}} \approx 613 {min}^{- 1}$$

If the outer diameter of the disc is 288 mm, then:

$$φ ( {t}_{end} ) = \frac{r ( {t}_{end} )}{a} = \frac{288 mm}{0.0239 mm} \approx 12000$$

And therefore:

$$ω ( {φ}_{end} ) \approx 42000 \cdot 1 / min \cdot \frac{1}{\sqrt{{( 12000 )}^{2} + 1}} \approx 347 {min}^{- 1}$$

As mentioned, this is the formal description of the process for one laser and processing head.

In order to maintain a low level of heat-input and a high level of process reliability, it is proposed in the present invention to work with preferably two or even more preferably at least three laser and processing heads (LPH) with lower laser power levels preferably less or equal to 6 kW simultaneously on the same surface to be coated, minimizing the total harm of optical components and maximizing the process reliability.

If more than one LPH is used. the polar coordinates of the n-th LPHₙ is then noted as (rₙ, φₙ).

According to a first preferred embodiment of the present invention, the LPHs are simultaneously moved from the inner radius to the outer radius with r(t)=r₁(t)=r₂(t)= . . . =rₙ(t), and

$${φ}_{i} = {φ}_{1} - 2 π \cdot ( i - 1 ) / n for i = 1 … n$$

where n is the number of LPHs used.

As a consequence of using n LPHs, the distance d between two adjacent lines deposited as measured along a line starting from the center point of the spiral at an angle φ can be described by the formula:

$$d = ( a * φ ) / n$$

As the distance between two adjacent lines deposited is kept constant in order to provide the overlap defined, the increment “a” can be increased by multiplying it with the number n of LPHs used:

$$a = n * \frac{D \cdot ( 100 \% - x ) / 100 \%}{2 π}$$

The invention will now be described in detail with one however not limiting example.

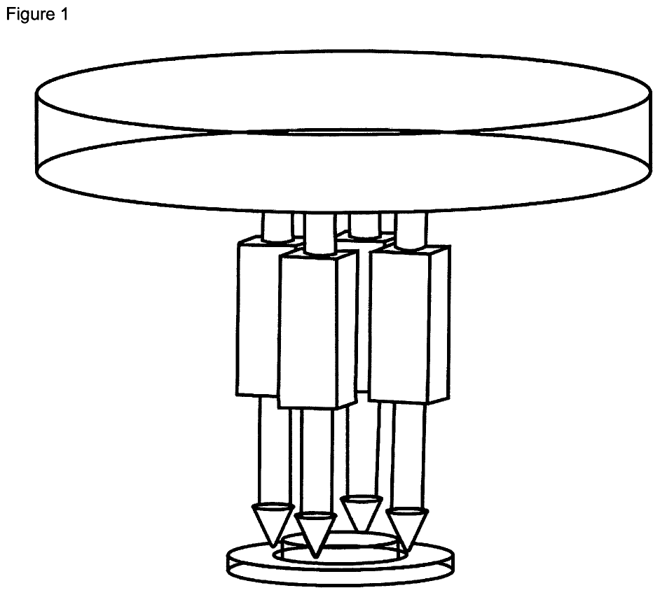

FIG. 1 shows the setup for laser cladding of a brake disc with 4 LPHs.

The example shows the laser cladding of one brake disc with n=4 LPHs simultaneously. A brake disc with inner diameter of 163 mm and outer diameter of 288 mm is to be laser cladded. The four LPHs do have the following positions at the beginning (in polar coordinates):

1. (163 mm; 6800)

2. (163 mm; 6800-2π·1/4)

3. (163 mm; 6800-2π·2/4)

4. (163 mm; 6800-2π·3/4)

As the relative speed of the laser beam on the surface to be coated is 100 m/min for all LPHs, the disc rotates at the beginning with 613 rpm. In order to reach an overlap of 90% of the cladding lines with four LPH the increment “a” can now be chosen to be 4·0.0239 mm=0.095 mm.

As all LPHs preferably move at the same speed in radial direction from the inner to the outer diameter of the friction surface of the brake disc to be laser cladded, the angular velocity of the brake disc can be the same for all of them.

In the example as given above each individual line deposited has a length of 73.8 m leading to process time per friction surface to be laser cladded of 44.3 seconds, which is less than half the time needed for coating the same surface using a high power laser of 20 kW. At the same time, lower power of the LPHs used in the example reduces the risks of using high power lasers as mentioned above.

This is an example with four LPH. The one skilled in the art understands that another number of LPH may be chosen and the angular positioning of the LPHs can be varied.

The one skilled in the art understands as well that all LPHs might start to laser clad at the same time or that there might be a delay of the cladding process for example to start the cladding of the second LPH at the same angular position of the first cladding and so on.

The example was described with starting with the inner diameter, cladding to the outer diameter. The one skilled in the art understands that starting with the outer diameter and finishing with the inner diameter is as well an option.

As the one skilled in the art knows, brake discs typically have a first friction surface and a second friction surface. First the first friction surface may be coated according to the present invention and then the second friction surface may be coated according to the present invention.

In this disclosure a method to produce a coated brake disc was described, the method comprising the steps of:
providing a brake disc, preferably an iron cast brake disc and/or an uncoated brake disc, with a first and a second friction surface
coating at least part of the first friction surface by a laser cladding process.

For the method more than one, preferably two or especially preferred at least three laser and processing heads are used and at least during part of the laser cladding process the lasers and processing heads are used simultaneously at different locations of the first friction surface.

According to one embodiment during at least part of the laser cladding process the brake disc is rotated around its rotation axis and the distance of the lasers and processing heads to the rotation axis at the beginning of the part of the process is chosen to be the same and then the distance is simultaneously changed in such a manner that at any time within the part of the laser cladding process each one of the lasers and processing heads has the same distance to the rotation axis as the others of the at least three lasers and processing heads.

If the angular position of the lasers and processing heads is described as

$${φ}_{i} for i = 1 … n$$

It is preferred that the lasers and processing heads are positioned in such a way that the following condition is fulfilled:

$${φ}_{i} = {φ}_{1} - 2 π \cdot ( i - 1 ) / n for i = 1 … n$$

if n is the number of the lasers and processing heads.

The method may then be performed in such a way that the deposition start of the i^{th} laser and processing head is delayed until the brake disc rotated by an angle of

$$2 π \cdot ( i - 1 ) / n$$

What is claimed is:

1. A method to produce a coated brake disc, the method comprising the steps of:
providing a brake disc with a first and a second friction surface,
coating at least part of the first friction surface by a laser cladding process wherein for the laser cladding process more than one, preferably two or especially preferred at least three laser and processing heads are used and at least during part of the laser cladding process the laser and processing heads are used simultaneously at different locations of the first friction surface.

2. The method according to claim 1, wherein during at least part of the laser cladding process the brake disc is rotated around its rotation axis and the distance of the lasers and processing heads to the rotation axis at the beginning of the part of the process is chosen to be the same and then the distance is simultaneously changed in such a manner that at any time within the part of the laser cladding process each one of the at least three laser and processing heads has the same distance to the rotation axis as the others of the at least three laser and processing heads.

3. The method according to claim 2, wherein the angular position of the lasers and processing heads is described as
$${φ}_{i} for i = 1 … n$$
and that the lasers and processing heads are positioned in such a way that the following condition is fulfilled:
$${φ}_{i} = {φ}_{1} - 2 π \cdot ( i - 1 ) / n for i = 1 … n$$
if n is the number of the lasers and processing heads.

4. The method according to claim 3, wherein the deposition start of the i^{th} laser and processing head is delayed until the brake disc rotated by an angle of
$$\underline{2 π \cdot ( i - 1 ) / n .}$$
